(19) United States
(12) Patent Application Publication
(10) Pub. No.: US 2023/0314078 A1
(43) Pub. Date: Oct. 5, 2023

(54) DEVICE AND METHOD FOR MAINTAINING EFFICIENT A TAPPING CHANNEL OF A FURNACE FOR THE PRODUCTION OF METAL

(71) Applicant: MORE s.r.l., Gemona del Friuit (IT)

(72) Inventors: Andrea FORNASIERE, Buja (IT); Marco Amerigo MICHELINI, San Daniele Del Friuli (IT)

(21) Appl. No.: 18/127,737

(22) Filed: Mar. 29, 2023

(30) Foreign Application Priority Data
Mar. 29, 2022 (IT) 102022000006164

(51) Int. Cl. F27D 3/15; F27B 3/19

(52) U.S. Cl. CPC F27D 3/1509; F27D 3/1545; F27B 3/19; F27D 2201/00

(57) ABSTRACT

A device for maintaining efficient a tapping channel of a furnace for the production of metal, includes a bearing structure and a mobile support means associated with the bearing structure. An operating arm is associated with the support means and terminally provided with a rod. A linear positioner is configured to move the support means along an elongation axis. A corresponding method for maintaining efficient a tapping channel of a furnace for the production of metal is also provided.

### FIELD OF THE INVENTION

The present invention concerns a device for maintaining efficient, that is, for cleaning and/or preheating, a tapping channel of a furnace for the production of metal, in particular an electric arc furnace, having a tapping hole located in an eccentric position with respect to the center of the furnace and known to persons of skill in the field as “Eccentric Bottom Tapping” EBT or as “offset bottom tapping” OBT.

### BACKGROUND OF THE INVENTION

Apparatuses for the production of metal material are known, which comprise a melting furnace, for example an electric arc furnace, provided with at least one metal container, called “shell”, suitable to receive the liquid metal produced by the melting. The combination of the metal container and the refractory lining is called “crucible”. The furnace also comprises a covering roof, or covering panel, which may have apertures for the passage of the electrodes that enter the crucible in order to generate the electric arc, and one or more apertures to extract the fumes. On the bottom, also known by the term “hearth”, or on the side of the crucible, there are normally means for transferring the liquid metal into another container, commonly called “ladle”, in order to transport it to the subsequent treatment plants. This operation is commonly called “tapping”.

Solutions are known in which these means for transferring the liquid metal comprise a tapping channel with a substantially vertical axis which passes through the hearth of the furnace in a decentralized position with respect to the center of the furnace (EBT or OBT).

The tapping channel is opened and closed by acting on mechanical means to close the tapping channel. In order to prevent liquid steel or slag from infiltrating therein and solidifying during melting, thus blocking it, the tapping channel is filled with an adequate quantity of sand or granular material. In contact with the liquid steel, the upper part of this filling sinters and creates a continuous barrier at the top of the tapping channel.

When the appropriate conditions of temperature and chemical analysis of the steel bath produced are reached, the mechanical closing means located at the base of the channel are removed. The sand falls due to gravity and the sintered cap breaks due to the action of the pressure exerted by the liquid bath, letting the steel itself flow out into the metallurgical container below, called ladle.

It is possible that, at the end of the tapping, residues of solidified metal or slag remain above the tapping channel, preventing the activity of filling it with sand from above, that is, decreasing the useful section of the tapping channel or, at worst, obstructing it. Sometimes it happens that residues of solid material of metal or even non-metal origin (pieces of refractory material, cement or graphite electrodes, slag, . . . ) get stuck inside the tapping channel, obstructing it or blocking access thereto. Should this happen, it would not be possible to correctly fill it with sand, nor to tap the metal produced in subsequent melting, therefore it is necessary to maintain the tapping channel always free from obstructions, even partial, both inside and above it.

For this purpose, mechanical devices are known, suitable for cleaning the tapping channel Among these, a device for cleaning the tapping channel is known which comprises a support structure attached to the lateral wall of the furnace and in which a first fixed tubular member is housed. A second mobile tubular member is disposed telescopically inside the first fixed tubular member and is moved, between two extreme positions, by means of a hydraulic cylinder. At its end, the second tubular member comprises a cantilevered arm on which a rod is mounted which, during the ascending movement of the second tubular member, allows to eliminate the obstructions present in the tapping channel.

One disadvantage of this known device is that the travel of the second fixed member is limited by the space available for housing it, that is, the vertical space present inside the first tubular fixed member, this latter, in any case, having to remain under the covering roof of the furnace in order not to interfere with the latter during the furnace loading cycle, which entails opening it with a roto-translation movement, and with other equipment.

Due to these limitations, this known device is not able to remove any metal residues deposited in the upper part of the tapping channel, given that in order to effectively carry out this operation it is essential that the rod protrudes inside the hearth of the furnace well above the refractory lining, in order to lift these residues up to the point of causing them to move.

An example of such a device is disclosed in document US 2021/318069 A1.

Other solutions described in documents GB 837 781 A and U.S. Pat. No. 4,265,433 concern, respectively, the application of gaseous fluids in furnaces for refining steel and an apparatus for applying refractory material on eroded portions of the internal surface of a tapping hole of a converter.

There is therefore a need to perfect a device and method for maintaining efficient a tapping channel of a furnace for the production of metal which can overcome at least one of the disadvantages of the state of the art.

To do this it is necessary to solve the technical problem of increasing the travel of the second tubular member and therefore of the rod in order to pass through the tapping channel effectively and for a longer segment.

In particular, one purpose of the present invention is to provide a device for maintaining efficient a tapping channel of a furnace for the production of metal which has limited bulk, is particularly compact, and allows to pass through the tapping channel and reach the inside of the crucible with a bigger travel.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, and to resolve the technical problem disclosed above in a new and original way, also achieving considerable advantages compared to the state of the prior art, a device according to the present invention has been embodied for maintaining efficient a tapping channel of a furnace for the production of metal. In the field of application of the present invention, the tapping channel has a substantially vertical axis.

The device comprises a bearing structure with which there are associated mobile support means with which there is associated an operating arm, preferably substantially L-shaped, with which there is terminally associated a rod configured to mechanically free, and possibly to heat, the tapping channel and/or oxy-fuel cut an occluding material that partly or totally blocks the tapping channel.

The device comprises a linear positioner configured to move the support means along an elongation axis. The elongation axis is advantageously vertical or sub-vertical.

In accordance with one aspect of the present invention, the device comprises movement means integral with the support means and associated with both the bearing structure and also with the operating arm in order to move the operating arm sliding on the first support means along the elongation axis, in a manner coordinated with and consequent to the movement of the first support means.

According to the invention, only the linear positioner constitutes a motorization for the support means and consequently for the operating arm by means of the movement means.

Preferably, the device of the present invention comprises a single linear positioner.

In accordance with another aspect of the present invention, the movement means are idle. In other words, the movement means are without motorization, that is, they are subjected to the action of the support means as well as their own weight force.

In accordance with another aspect of the present invention, the movement means comprise at least a first pulley integral with the support means and a transmission member returned on the pulley and terminally attached to the bearing structure on one side and to the operating arm on the other side.

In accordance with another aspect of the present invention, the movement means also comprise a second pulley opposite and aligned with the first pulley and on which the transmission member is returned.

In accordance with another aspect of the present invention, the support means comprise a sliding member having an upper and a lower end, a first return portion in correspondence with the upper end on which the first pulley is attached, and an opposite and aligned second return portion in correspondence with the lower end on which the second pulley is attached. This configuration is particularly advantageous because it allows to contain the transverse bulk of the device in both the positions of minimum and maximum extension of the support means and of the operating arm.

In accordance with another aspect of the present invention, the sliding member also comprises a connection portion disposed near the lower end and to which the linear positioner is connected, wherein the linear positioner comprises a cylinder, preferably hydraulic or pneumatic. According to one possible variant, the positioner can comprise a motor with reduction gear and mechanical transmission of the rack-pinion type, or other similar or comparable mechanical systems, such as for example hydraulic jacks with grub screw or ball recirculation, or even electric motors with chains/pulleys or a winch.

In accordance with another aspect of the present invention, the transmission member comprises a chain having two distinct and separate segments, of which a first segment is returned on the first pulley and a second segment is returned on the second pulley.

In accordance with another aspect of the present invention, the transmission member comprises a single chain returned at the upper part on the first pulley and at the lower part on the second pulley. This configuration advantageously allows to reduce the number of components and the complexity of the device, while maintaining all its functionalities unchanged.

In accordance with another aspect of the present invention, the operating arm is equipped with means for delivering one or more gases which comprise a plurality of channels made in a terminal portion of the rod and fluidly connected with the outside to deliver the gases along the tapping channel, or above it, in order to preheat it and/or to heat and oxy-fuel cut the occluding material.

The present invention also concerns a method for maintaining efficient a tapping channel, advantageously having a substantially vertical axis, of a furnace for the production of metal, comprising:
an alignment step, in which a bearing structure is positioned with respect to the furnace in order to align a rod of an operating arm, preferably substantially L-shaped, with the tapping channel,
an active movement step, in which support means, associated in a mobile manner with the bearing structure and supporting the operating arm, are moved by means of a linear positioner along an elongation axis in a first direction causing, by means of movement means which are integral with the support means and associated with both the bearing structure and also with the operating arm, a coordinated movement of the operating arm in the same first direction.

The method provides another movement step, active or passive, in which the support means move, actively or passively, in an opposite second direction and the movement means move the operating arm sliding on the first support means along the elongation axis in the same second direction.

In accordance with another aspect of the present invention, the active and passive movement steps are performed in such a way that the movements along the elongation axis occur in an alternating manner in opposite directions, with the aim of inserting and extracting the rod into/from the tapping channel in order to exert a mechanical action able to remove the occluding material.

In accordance with another aspect of the present invention, if the mechanical action is not sufficient to remove the occluding material, the rod is positioned at a suitable distance with respect to the occluding material by acting on the linear positioner, on the basis of an operating signal generated by a sensor, such as a position transducer of the rod for example, wherein, once the suitable distance has been reached, a mixture of combustible and comburent gas is fed by means of delivery means of the rod in order to generate a flame in correspondence with a terminal portion of the rod, with the aim of heating the occluding material.

In accordance with another aspect of the present invention, oxygen is fed by means of the delivery means, alternatively or simultaneously, in order to oxy-fuel cut the occluding material.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic lateral section view of a device for maintaining efficient a tapping channel of a furnace for the production of metal, according to the present invention;

FIG. 2 is a section along the line II-II of FIG. 1;

FIGS. 3-5 show a movement sequence of the device of FIG. 1;

FIG. 6a is a section view along the line VI-VI of FIG. 1, while FIGS. 6b-6c are possible variants of FIG. 6a;

FIG. 7 shows a variant of the device of FIG. 1.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF AN EMBODIMENT OF THE PRESENT INVENTION

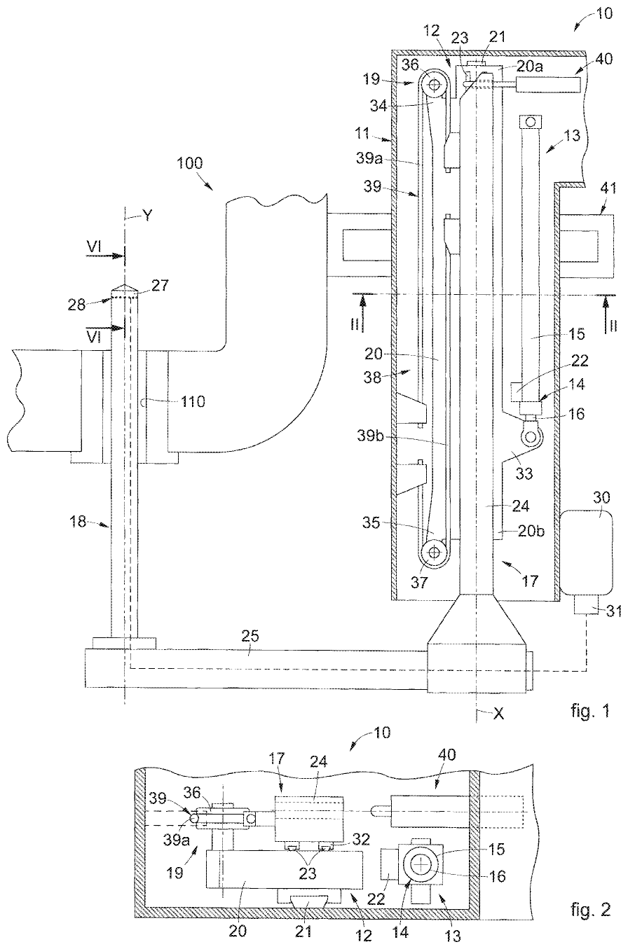

With reference to FIG. 1, a device 10 according to the present invention comprises a bearing structure 11 with which there are associated both mobile support means 12 and also a linear positioner 13. The device 10 is functional for maintaining efficient a tapping channel 110 of a furnace 100 for the production of metal.

In particular, the device 10 can be used to maintain efficient a tapping channel 110 with a substantially vertical axis. The tapping channel 110 passes through the hearth, that is, a bottom or lower wall, of the furnace 100 in a decentralized position with respect to the center of the furnace 100 (EBT or OBT).

The linear positioner 13, which in this specific case comprises a hydraulic or pneumatic cylinder 14 having a cylindrical body 15 and a shaft 16, is configured to move the support means 12 along an elongation axis X, vertical or sub-vertical, with respect to the bearing structure 11. The travel of the support means 12 is equal or proportional to the travel of the cylinder 14. Alternatively, the linear positioner 13 can comprise reducer-pinion-rack gear couplings, or hydraulic jacks with grub screw or ball recirculation, or again electric motors with chains/pulleys.

The device 10 comprises an operating arm 17 associated sliding with the support means 12 and with which a rod 18 is terminally associated. The rod 18 is configured to mechanically free the tapping channel 110 and possibly to also heat and oxy-fuel cut an occluding material, for example drips and residual materials, which blocks the tapping channel 110, as described below, if it cannot be displaced by mechanical action alone.

By the term “associated” we mean that the rod 18 can be mounted/attached to the operating arm both in a fixed manner, for example by means of welding, and also in a removable manner, for example by means of a connection flange.

The linear positioner 13 can comprise a sensor or position detection device 22, such as a position transducer and/or a device based on indirect measurements, such as the load on the actuator itself for example, configured to control the movement of the rod 18. In fact, particularly if the rod 18 has to oxy-fuel cut the occluding material which blocks the tapping channel 110, the rod 18 has to remain distanced from the obstacle, otherwise there could be a risk of melting of the rod 18 itself.

The device 10 comprises movement means 19 integral with the support means 12 and associated both with the bearing structure 11 and also with the operating arm 17 in order to move the operating arm 17 along the same elongation axis X in a manner that is coordinated with and consequent to the movement of the support means 12.

The movement means 19 are idle, that is, they are not motorized. Therefore the movement of the operating arm 17 is caused indirectly by the action of the cylinder 14 on the support means 12.

In other words, the support means 12 are sliding with respect to the fixed bearing structure 11, while the operating arm 17 is, in turn, sliding with respect to the support means 12, so that the overall movement is of the telescopic type. With a single drive by means of the linear positioner 13 it is therefore possible to obtain a wider travel that that guaranteed by traditional devices.

The movement means 19 therefore allow to amplify the excursion of the operating arm 17 and therefore of the rod 18, which in the prior art is limited only to the travel of the cylinder 14. In this case, the overall travel is given by the travel provided to the support means 12 by the linear positioner 13 and by the travel provided to the operating arm 17 by the movement means 19.

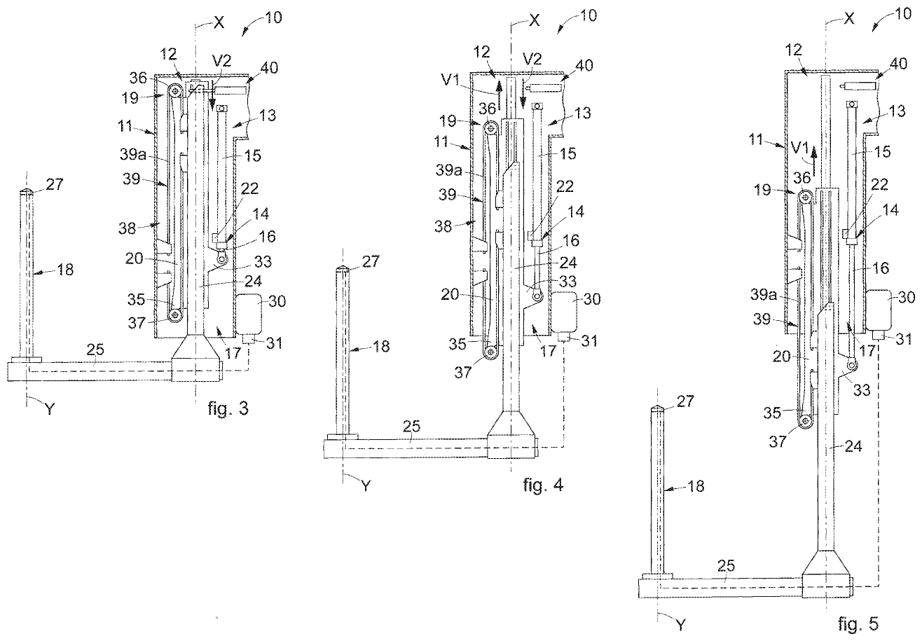

The support means 12 and the operating arm 17 are therefore mobile, in a coordinated manner, between a position of minimum extension (FIG. 3) and a position of maximum extension (FIG. 5), which are alternated in order to operate the insertion and extraction of the rod 18 with respect to the tapping channel 110.

Since the overall travel of the operating arm 17 is increased, it is possible to size the length of the rod 18 to reach the higher part of the tapping channel 110 well above the refractory lining and effectively remove all the blockages, all this while keeping the vertical bulk of the device 10 contained, which therefore does not interfere with the normal operation of the furnace 100.

The fixed bearing structure 11 can be a box, open at least at the bottom to allow the extension of the support means 12 and of the operating arm 17.

The support means 12 comprise a sliding member 20, which can consist of a slide or wheels resting on tracks, or other equivalent system. The sliding member has a prevalent extension along the elongation axis X between two upper 20a and lower ends 20b thereof.

The sliding member 20 is sliding with respect to the bearing structure 11 along first guide means 21 associated with the latter and it is provided with second guide means 23 which develop parallel to the elongation axis X between the upper 20a and lower end 20b, along which the operating arm 17 is sliding.

The operating arm 17 is preferably L-shaped, thus comprising a first longitudinal element 24, which is the one actually sliding on the second guide means 23 of the sliding member 20, and a second element 25 transverse to the first element 24, which is the one with which the rod 18 is terminally associated. The first element 24 and the second element 25 determine the L shape of the operating arm 17.

The second element 25 is made in a single body with the first element 24 or it can be connected to one end thereof, for example by means of a flanged connector or other connection means substantially known to a person of skill in the art.

The first element 24 I s substantially parallel to the elongation axis X.

The rod 18 substantially parallel to the first element 24 extends along its own development axis Y and is provided with a terminal portion 27, the primary function of which is to mechanically free the tapping channel 110 as a result of the overall movement of the operating arm 17, and therefore of the rod 18, along the elongation axis X.

The operating arm 17 can be equipped with means 28 for delivering gases which comprise a plurality of delivery channels 29 created in the terminal portion 27 and fluidly connected to the outside to deliver the gases into the tapping channel 110 in order to preheat it and possibly also to oxy-fuel cut the occluding material which blocks the tapping channel 110.

The system for feeding the gases to the delivery channels 29 can be single, or it can consist of two independent systems, in case creating a flame with separate supply of fuel and comburent is required. In this way, it is possible to decide whether to create a heating flame or to vary the combustion ratio until pure oxygen is fed to melt and oxy-fuel cut the occluding material which blocks the tapping channel 110.

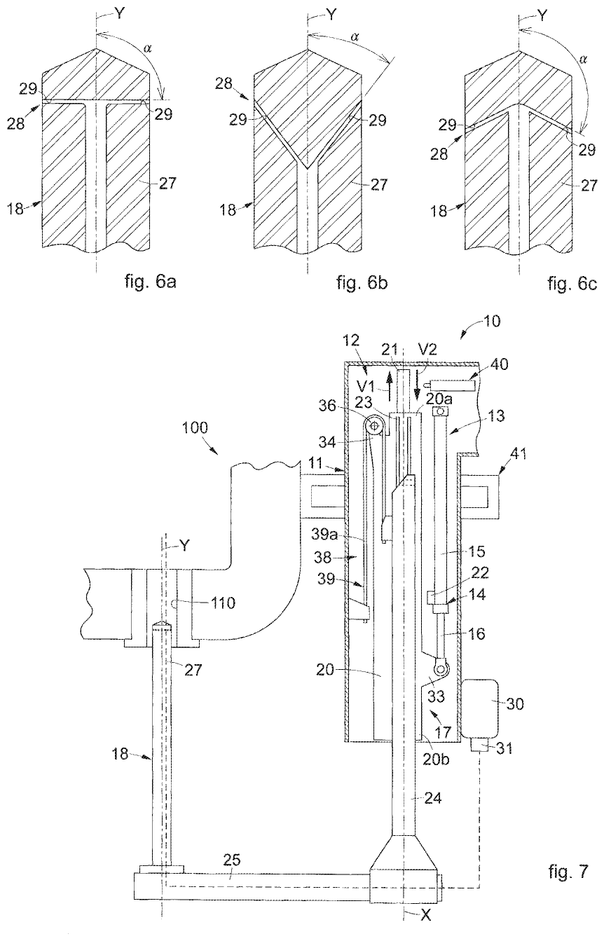

The delivery channels 29 are inclined by an angle of inclination a with respect to the development axis Y. The angle of inclination a can be equal to (FIG. 6a), smaller (FIG. 6b) or greater than (FIG. 6c) 90°. The delivery channels 29 can also be parallel to the development axis Y. The channels 29 can all have the same inclination or different inclinations, one from the other or in groups.

The device 10 comprises a storage member 30, configured to contain a compressed or liquefied gas, and a pumping member 31, both serving the delivery means 28. The storage member 30 and the pumping member 31 can be on board the device 10, for example associated with the bearing structure 11, or in any case in a suitable position.

Alternatively, suitable gas flow regulation and control systems can be located in a remote position of the plant and be suitably connected to the device 10.

The gas can be oxygen, air, nitrogen, but also methane, propane, butane, acetylene, etc. or other mixtures of combustible gases with the aim of heating and oxy-fuel cutting the occluding material which blocks the tapping channel 110.

The operating arm 17 is provided with a sliding block 32 configured to couple sliding to the second guide means 23.

The sliding block 32 can be part of the operating arm 17, in particular of the first element 24, or a distinct and separate component from the operating arm 17 and connected thereto in a per se known manner.

The first guide means 21 and the second guide means 23 can comprise, for example, longitudinal grooves or ribs parallel to the elongation axis X, rolling elements for reducing friction, magnetic elements, or other elements for promoting or transmitting sliding which are essentially known to the person of skill in the art.

The sliding member 20 comprises a connection portion 33 disposed between the upper 20a and lower end 20b, in particular it is closer to the lower end 20b, and to which one end of the shaft 16 of the cylinder 14 is attached.

The sliding member 20 also comprises a first return portion 34, or upper return portion, which is located in correspondence with the upper end 20a of the sliding member 20, and a second return portion 35, or lower return portion, which is located in correspondence with the lower end 20b of the sliding member 20.

The return portions 34, 35 can conveniently, although not necessarily, be aligned vertically and develop on a same side of the sliding member 20.

Similarly, the connection portion 33 can conveniently develop on an opposite side of the sliding member 20, or in any case a side different from that where the return portions 34, 35 are located.

The movement means 19 comprise a first pulley 36 attached in correspondence with the first return portion 34, a second pulley 37 attached in correspondence with the second return portion 35 and at least one transmission member 38, which in this specific case is a chain 39, returned on the first and second pulley 36, 37 and attached both to the bearing structure 11 and also to the operating arm 17.

The pulleys 36, 37 are conveniently aligned with each other parallel to the elongation axis X.

Advantageously, the transmission member 38 is overall parallel to the elongation axis X, except for the return segments which are wound around the pulleys 36, 37.

The pulleys 36, 37 have a horizontal rotation axis and are idle, therefore the device 10 is motorized only by means of the cylinder 14.

The chain 39 can be made in two distinct segments 39a, 39b, of which a first segment, or upper segment, 39a is returned on the first pulley 39 while a second segment, or lower segment, 39b is returned on the second pulley 37. Conveniently, but not necessarily, the length of the first segment 39a is the same as the length of the second segment 39b.

Both segments 39a, 39b are attached, with respect to their ends, to the bearing structure 11 on one side and to the operating arm 17 on the other side. The segments 39a, 39b can be constrained to the bearing structure 11 and to the operating arm 17 in common connection points, or in distinct connection points.

According to one variant, the chain 39 can be made in a single section, being in any case always constrained both to the bearing structure 11 and also to the operating arm 17.

According to another variant, FIG. 7, the movement means 19 can comprise only the first pulley 36 and the chain 39 returned thereon.

The device 10 preferably also comprises a safety member 40 able to be activated in order to sustain the sliding member 20, consequently preventing the movement of the operating arm 17. The safety member 40 is activated to unload the weight from the cylinder 14, for example to perform maintenance operations.

The device 10 comprises positioning means 41 associated with the bearing structure 11 and configured to move it, in particular to allow its rotation, with respect to the furnace 100 in order to correctly orient the rod 18 with respect to the tapping channel 110.

Such rotation is operated around a substantially vertical axis, parallel to or coincident with the elongation axis X.

The positioning means 41 are configured, in addition to correctly position the rod 18, to displace the device 10 into a lateral parking position so that it does not interfere with the tapping operations. Moreover, it is advisable that in this parking position the device 10 is well sheltered from the flames and thermal radiation typical of tapping operations.

The operation of the device 10 described heretofore, which corresponds to the method according to the present invention, comprises the following steps:
an alignment step, in which the bearing structure 11 is positioned with respect to the furnace 100 in order to align the rod 18 with the tapping channel 110,
an active movement step, in which the support means 12, which are initially in a fully extended or partly extended position, are moved in a first direction V1, by means of the cylinder 14, along the elongation axis X, upward with reference to FIG. 4 or 5. Consequently, the movement means 19 transmit motion to the operating arm 17 which moves in the same first direction V1, upward.

The method also comprises another movement step which can be active or passive, coordinated with and consequent to an active or passive movement of the support means 12 in an opposite second direction V2. In this step, the movement means 19 move the operating arm 17 sliding along the elongation axis X in the second direction V2 with respect to the support means 12, downward with reference to FIG. 3 or 4.

The upward (active) and downward (active or passive) movement steps are performed in such a way that the movements along the elongation axis X occur in an alternate manner in opposite directions V1, V2, with the aim of inserting and extracting the rod 18 into/from the tapping channel 110.

By “active” movement we mean a movement caused/controlled by the active action of the linear positioner 13. By “passive” movement we mean a movement which occurs by gravity due to the very weight of the mobile components of the device 10. The downward movement (second direction V2) can also be partly passive and partly active, by which we mean a “controlled” descent of the operating arm 17.

It is clear that modifications and/or additions of parts may be made to the device and method for maintaining efficient a tapping channel of a furnace for the production of metal as described heretofore, without departing from the field and scope of the present invention, as defined by the claims.

It is also clear that, although the present invention has been described with reference to some specific examples, a person of skill in the art will be able to achieve other equivalent forms of device and method for maintaining efficient a tapping channel of a furnace for the production of metal, having the characteristics as set forth in the claims and hence all coming within the field of protection defined thereby.

In the following claims, the sole purpose of the references in brackets is to facilitate their reading and they must not be considered as restrictive factors with regard to the field of protection defined by the same claims.

1. A device for maintaining efficient a tapping channel, having a substantially vertical axis, of a furnace for the production of metal, comprising a bearing structure with which there are associated support means with which there is associated a preferably L-shaped operating arm with which there is terminally associated a rod configured to mechanically free said tapping channel, and optionally to heat and/or oxy-fuel cut an occluding material that blocks said tapping channel, and a linear positioner configured to move said support means along an elongation axis, wherein the device comprises movement means integral with said support means and associated with both said bearing structure and also with said operating arm which is moved sliding on said first support means along said elongation axis in a manner coordinated with and consequent to the movement of said first support means.

2. The device as in claim 1, wherein said movement means are without motorization.

3. The device as in claim 1, wherein said movement means comprise at least a first pulley integral with said support means, and a transmission member returned on said first pulley and terminally attached to said bearing structure on one side and to said operating arm on the other side.

4. The device as in claim 3, wherein said movement means also comprise a second pulley opposite and aligned with said first pulley.

5. The device as in claim 4, wherein said support means comprise a sliding member having an upper and a lower end, a first return portion in correspondence with said upper end on which said first pulley is attached, and an opposite and aligned second return portion in correspondence with said lower end on which said second pulley is attached.

6. The device as in claim 5, wherein said sliding member comprises a connection portion disposed near said lower end and to which said linear positioner is connected.

7. The device as in claim 6, wherein said linear positioner is selected from a group comprising a hydraulic or pneumatic cylinder, a motor configured to transmit a movement to said sliding member by means of a rack-pinion coupling, or by means of a winch, or by means of pulleys, or by means of a crown-chain coupling, a hydraulic jack with grub screw or ball recirculation.

8. The device as in claim 3, wherein said transmission member comprises a chain having distinct and separate first and second segments, of which said first segment is returned on said first pulley and said second segment is returned on said second pulley.

9. The device as in claim 3, wherein said transmission member comprises a single chain returned at the upper part on said first pulley and at the lower part on said second pulley.

10. The device as in claim 1, wherein said operating arm is equipped with means for delivering one or more gases which comprise a plurality of delivery channels made in a terminal portion of said rod and fluidly connected with the outside to deliver said gases along said tapping channel in order to preheat it, or to heat and oxy-fuel cut said occluding material.

11. A method for maintaining efficient a tapping channel, having a substantially vertical axis, of a furnace for the production of metal, comprising:
an alignment step, in which a bearing structure is positioned with respect to said furnace in order to align a rod of a preferably L-shaped operating arm with said tapping channel,
an active movement step, in which support means associated in a mobile manner with said bearing structure and supporting said operating arm are moved by means of a linear positioner along an elongation axis in a first direction causing, by means of movement means which are integral with said support means and are associated with both said bearing structure and also with said operating arm, a coordinated movement of said operating arm in the same first direction,
wherein said method comprises a subsequent active or passive movement step in which said support means move in an opposite second direction and said movement means move said operating arm sliding on said first support means along said elongation axis in the same second direction of movement.

12. The method as in claim 11, wherein said active and/or passive movement steps are performed in such a way that the movements along said elongation axis occur in an alternating manner in opposite directions of movement, with the aim of inserting and extracting said rod into/from said tapping channel in order to exert a mechanical action able to remove said occluding material.

13. The method as in claim 12, wherein if said mechanical action is not sufficient to remove said occluding material, said rod is positioned at a suitable distance with respect to said occluding material by acting on said linear positioner, on the basis of an operating signal generated by a position transducer of said rod, wherein, once said suitable distance has been reached, a mixture of combustible and comburent gas is fed by means of delivery means of said rod in order to generate a flame in correspondence with a terminal portion of said rod with the aim of heating the occluding material.

14. The method as in claim 13, wherein oxygen is fed by means of said delivery means, alternatively or simultaneously, in order to oxy-fuel cut said occluding material.
